(19) United States
(12) Patent Application Publication
(10) Pub. No.: US 2009/0019232 A1
(43) Pub. Date: Jan. 15, 2009

(54) SPECIFICATION OF COHERENCE DOMAIN DURING ADDRESS TRANSLATION

(75) Inventors: Sanjay R. Deshpande, Austin, TX (US); Bryan D. Marietta, Austin, TX (US); Michael D. Snyder, Austin, TX (US); Gary L. Whisenhunt, Austin, TX (US)

Correspondence Address: LARSON NEWMAN ABEL POLANSKY & WHITE, LLP, 5914 WEST COURTYARD DRIVE, SUITE 200, AUSTIN, TX, 78730, US

(73) Assignee: FREESCALE SEMICONDUCTOR, INC., Austin, TX (US)

(21) Appl. No.: 11/776,267

(22) Filed: Jul. 11, 2007

(51) Int. Cl. G06F 12/08

(52) U.S. Cl. 711/141; 711/E12.026

(57) ABSTRACT

A processing system includes a plurality of coherency domains and a plurality of coherency agents. Each coherency agent is associated with at least one of the plurality of coherency domains. At a select coherency agent of the plurality of coherency agents, an address translation for a coherency message is performed using a first memory address to generate a second memory address. A select coherency domain of the plurality of coherency domains associated with the coherency message is determined at the select coherency agent based on the address translation. The coherency message and a coherency domain identifier of the select coherency domain are provided by the select coherency agent to a coherency interconnect for distribution to at least one of the plurality of coherency agents based on the coherency domain identifier.

### FIELD OF THE DISCLOSURE

The present disclosure relates generally to processing systems having multiple coherency domains and more particularly to routing coherency messages between multiple coherency domains.

### BACKGROUND

In processing systems having multiple processors, it often is advantageous to maintain cache coherence—that is, to provide mechanisms that ensure consistency in the data shared between the processors. When one processor modifies its local copy of a shared data, a coherency protocol is utilized to make the modified data available to the other processors. This coherency protocol typically is implemented as coherency messages transmitted between the processors via one or more coherency interconnects.

In larger systems, the coherency message traffic can overwhelm the bandwidth of the coherency interconnect when the coherency messages are broadcast to all coherent components in the system. Accordingly, in some conventional systems, coherent components of the system are assigned to one or more coherency domains and the broadcast of coherency messages can be limited to those coherency agents of a particular coherency domain. In such systems, an indicator of the cache domain for a particular cached data is stored at the cache and when the cached data is modified, the coherency agent can speculatively assign the corresponding coherency domain identified from the cache to a coherency message generated as a result of the modification of the cache data. In the event that the speculated coherency domain was assumed incorrectly, the coherency agent expands the scope of the coherency message to include more coherency domains or broader coherency domains and retransmits the coherency agent. While this speculative process can reduce system-wide coherency message traffic when the coherency domain is correctly speculated, the rebroadcast of coherency messages for incorrectly speculated coherency domains can result in increased coherency message traffic, thereby contributing to the bottleneck at the coherency interconnect. Accordingly, an improved technique for domain-specific coherency message transmission would be advantageous.

### BRIEF DESCRIPTION OF THE DRAWINGS

The present disclosure may be better understood, and its numerous features and advantages made apparent to those skilled in the art by referencing the accompanying drawings.

FIG. 1 is a block diagram illustrating an example multiple-processor system utilizing coherency domain specification during memory address translation in accordance with at least one embodiment of the present disclosure.

FIG. 2 is a block diagram illustrating another example multiple-processor system utilizing coherency domain specification during memory address translation in accordance with at least one embodiment of the present disclosure.

FIG. 3 is a block diagram illustrating yet another example multiple-processor system utilizing coherency domain specification during address translation in accordance with at least one embodiment of the present disclosure.

FIG. 4 is a block diagram illustrating an example processor core utilizing a memory management unit (MMU) for determining a coherency domain of a coherency message in accordance with at least one embodiment of the present disclosure.

FIG. 5 is a diagram illustrating an example address translation table having coherency domain identifiers in accordance with at least one embodiment of the present disclosure.

FIGS. 6 and 7 are diagrams illustrating example routings of domain-specific coherency messages in accordance with at least one embodiment of the present disclosure.

The use of the same reference symbols in different drawings indicates similar or identical items.

### DETAILED DESCRIPTION

In accordance with one aspect of the present disclosure, a method is provided in a processing system comprising a plurality of coherency domains and a plurality of coherency agents. Each coherency agent is associated with at least one of the plurality of coherency domains. The method includes performing, at a select coherency agent of the plurality of coherency agents, an address translation for a coherency message using a first memory address to generate a second memory address. The method further includes determining, at the select coherency agent, a select coherency domain of the plurality of coherency domains associated with the coherency message based on the address translation. The method additionally includes providing the coherency message and a coherency domain identifier of the select coherency domain to a coherency interconnect for distribution to at least one of the plurality of coherency agents based on the coherency domain identifier.

In accordance with another aspect of the present disclosure, a processor device is provided. The processor device includes a coherency agent and a memory management unit. The memory management unit includes an address translation table comprising a plurality of entries. Each entry includes a first field to store a corresponding address value and a second field to store a coherency domain identifier of a corresponding coherency domain of a plurality of coherency domains.

In accordance with yet another aspect of the present disclosure, a system is provided. The system includes a plurality of coherency agents. Each coherency agent is associated with at least one of a plurality of coherency domains and comprising an address translation table. Each coherency agent is configured to generate a coherency message in response to a cache access at the coherency agent and determine a coherency domain identifier for the coherency message based on the address translation table and a first memory address associated with the cache access. The coherency domain identifier is associated with a select coherency domain of the plurality of coherency domains. The system further includes a coherency interconnect configured to distribute the coherency messages between select ones of the plurality of coherency agents based on the coherency domain identifier associated with the coherency message.

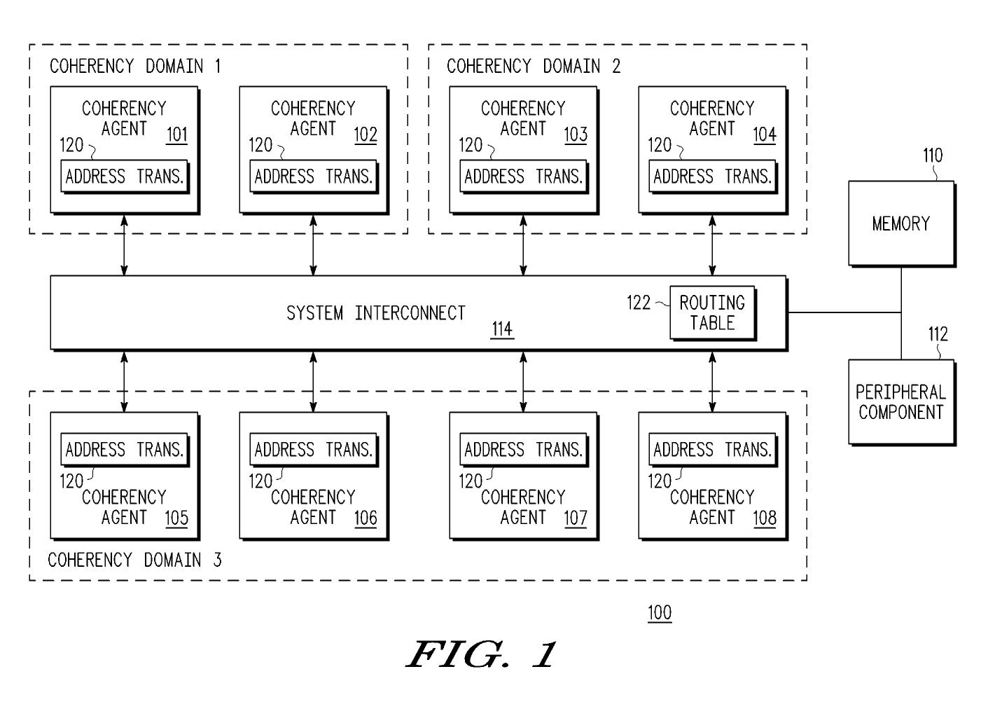

FIGS. 1-7 illustrate example techniques for coherency domain-specific coherency message transmission in a multiple-processor system. In one embodiment, the multiple-processor system is divided into a plurality of coherency domains, each having a corresponding domain identifier (DID). Each coherency agent of the multiple-processor system is assigned to one or more of the coherency domains. The address translation tables of the coherency agents can be configured to reflect which virtual addresses correspond to which coherency domain, such as a virtual page-by-page basis. In one embodiment, this configuration includes populating the page properties fields of each virtual address entry of the address translation tables with a corresponding DID or other representative value. Accordingly, when a coherency agent utilizes its associated address translation table to convert a virtual address associated with a coherency message to its corresponding physical address, the coherency agent further can determine the appropriate coherency domain for the coherency message by accessing the corresponding DID from the page properties of the indexed virtual-to-physical address entry. The DID then can be used by the coherency interconnect to limit the routing of the coherency message to only those coherency agents of the indicated coherency domain.

The term “coherency agent,” as used herein, refers to a component of a system that stores, accesses, modifies shared data of one or more coherent memories in a processing system, or participates in the coherency protocol with other components of the system (e.g., other coherency agents). Examples of coherency agents include, but are not limited to, processor cores with associated caches, stand-alone caches, and the like. For ease of discussion, certain aspects of the techniques disclosed herein are described in the illustrative context of coherency management by a processor core. However, the disclosed techniques can be implemented by other types of coherency agents using the guidelines provided herein without departing from the scope of the present disclosure. Further, the memory address translation techniques are described herein in the context of a memory management unit (MMU) for ease of illustration. These memory address translation techniques can be utilized in other contexts without departing from the scope of the disclosure.

FIGS. 1-3 illustrate example multiple-processor systems that determine a coherency domain for a coherency message during memory address translation for the coherency message in accordance with at least one embodiment of the present disclosure.

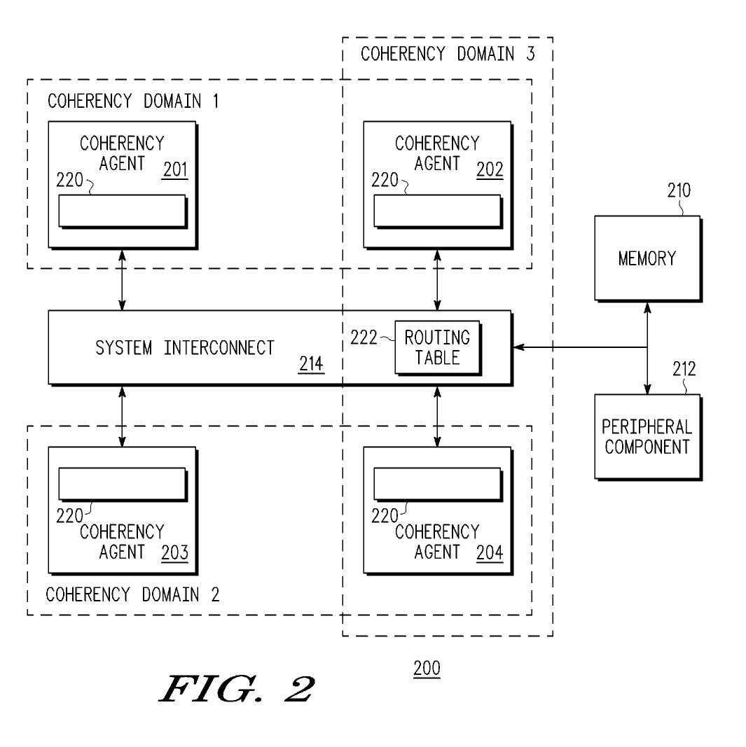

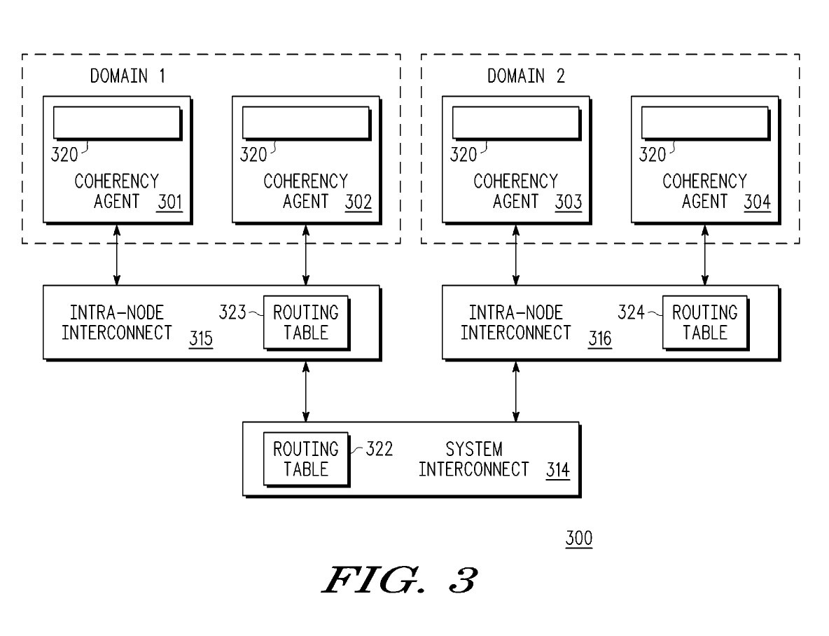

FIG. 1 illustrates an example of mutually-exclusive coherency domains utilizing a single interconnect, FIG. 2 illustrates an example of overlapping coherency domains, and FIG. 3 illustrates an example of coherency domains connected via a network of coherency interconnects. Other implementations can include hybrid combinations of the implementations of FIGS. 1-3.

FIG. 1 depicts a multiple-processor system 100 that includes a plurality of coherency agents, including coherency agents 101, 102, 103, 104, 105, 106, 107, and 108 (hereinafter, “coherency agents 101-108”), as well as a coherent memory 110 and a peripheral component 112 shared by the coherency agents 101-108. The coherency agents 101-108 each can include a processor core, stand-alone cache, and the like. The coherency agents 101-108, the coherent memory 110, and the peripheral component 112 are connected via a system interconnect 114, wherein the system interconnect 114 is configured to distribute coherency messages between the coherency agents 101-108, the shared memory 110 and the peripheral component 112. Further, the system interconnect 114, in one embodiment, is configured to distribute interprocessor messages and other traffic between the components of the multiple-processor system 100.

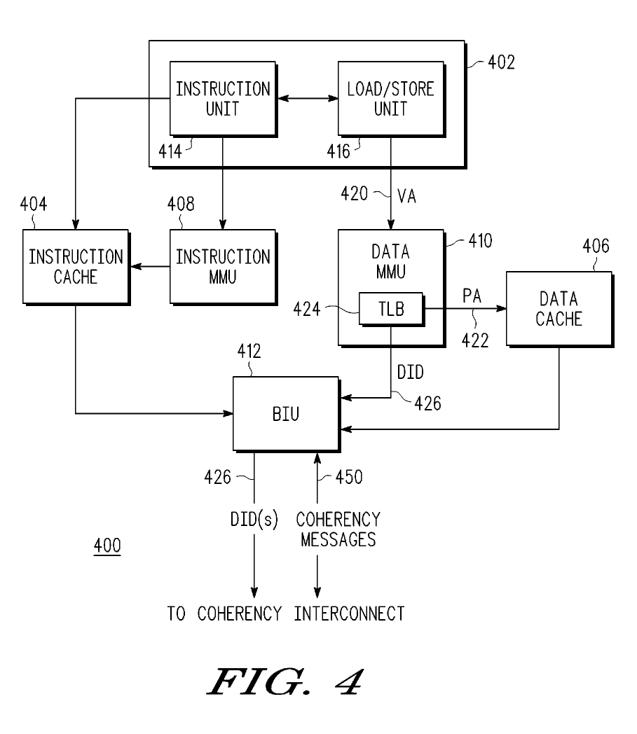

Each of the coherency agents 101-108 includes an address translation component 120 for translating virtual memory addresses to physical memory addresses. The address translation component 120 can be implemented as, for example, a memory management unit (MMU), as described in greater detail herein with reference to FIG. 4. In one embodiment, the address translation component 120 implements an address translation table having a plurality of entries, each entry for translation of a virtual address portion to a corresponding physical address portion and wherein each entry can have fields for indicating certain page properties, such as how data to the corresponding page is cached (e.g., write-through, not cached, etc), endianness (big endian or little endian), whether the page is guarded (e.g., whether speculative accesses are allowed), and the like. As described in greater detail herein, the page properties fields of the entries of the address translation table can include a domain identifier (DID) field to indicate which coherency domain or domains is associated with the corresponding virtual address (e.g., by virtual page number).

In the illustrated example, the multiple-processor system 100 is divided into three coherency domains (coherency domains 1-3), wherein the coherency agents 101 and 102 are assigned to coherency domain 1, the coherency agents 103 and 104 are assigned to coherency domain 2, and coherency agent 105, coherency agent 106, coherency agent 107, and coherency agent 108 are assigned to coherency domain 3. In one embodiment, the software executed at the multiple-processor system 100 controls which addresses are in which domains. Based on this coherency domain assignment, the address translation tables of the address translation components 120 of the coherency agents 101-108 are configured such that each virtual address entry includes a DID for the corresponding coherency domain.

In response to an operation that involves shared data (e.g., a read operation or a write operation) at one of the coherency agents 101-108, the coherency agent generates a coherency message for the operation. As part of the coherency message generation, the virtual address associated with the shared data is converted to a physical address by the address translation component 120 of the coherency agent. The address translation involves indexing an entry of the address translation table based on the virtual address and accessing a corresponding physical address portion, which is then used to generate the physical address. Further, the DID field of the indexed entry of the address translation table is accessed to determine the one or more DIDs associated with the virtual address. The coherency agent then provides a coherency message with the physical address to the system interconnect 114 along with the determined DIDs for transmission to the coherency agents assigned to the coherency domains identified by the determined DIDs. The DIDs can be provided as part of the coherency message, or the DIDs can be provided as a separate input to the system interconnect 114.

To facilitate routing of coherency domain-specific coherency messages, the system interconnect 114 includes a routing table 122 that identifies the correspondence between coherency agents and DIDs. Table 1 illustrates a basic implementation of the routing table 122 for the example of FIG. 1, where a “Y” indicates the system interconnect 114 is to deliver a coherency message to the corresponding coherency agent and a “N” indicates the system interconnect 114 is to avoid delivering the coherency message to the corresponding coherency agent.

TABLE 1
Routing Table 122 for FIG. 1

| | | | Agent | Agent | Agent | Agent | Agent | Agent |
|---|---|---|---|---|---|---|---|---|
| DID | Agent 101 | Agent 102 | 103 | 104 | 105 | 106 | 107 | 108 |
| 1 | Y | Y | N | N | N | N | N | N |
| 2 | N | N | Y | Y | N | N | N | N |
| 3 | N | N | N | N | Y | Y | Y | Y |
| — | Y | Y | Y | Y | Y | Y | Y | Y |

Thus, the system interconnect 114 can limit the distribution of the coherency message to only those coherency agents associated with coherency domains identified by the coherency message based on a mapping of the DID(s) supplied with a coherency message to the routing information of the routing table 122. In the event that no DID is supplied (or a default or global DID “—” for the entire system), the coherency message can be broadcast to all coherency agents of the multiple-processor system 100.

FIG. 2 depicts an alternate multiple-processor system 200 that includes a plurality of coherency agents, including coherency agents 201, 202, 203, and 204 (hereinafter, “coherency agents 201-204”), a coherent memory 210, and a peripheral component 212, wherein the coherent memory 210 and peripheral component 212 are shared by the coherency agents 201-204. The coherency agents 201-204 each can include an address translation component 220 (corresponding to the address translation component 120, FIG. 1). The coherency agents 201-204, the coherent memory 210, and the peripheral component 212 are connected via a system interconnect 214 (corresponding to the system interconnect 114, FIG. 1), wherein the system interconnect 214 is configured to distribute coherency messages between the coherency agents 201-204, the shared memory 210 and the peripheral component 212, as well as interprocessor messages and other system traffic.

In the illustrated example, the multiple-processor system 200 is divided into three coherency domains (coherency domains 1-3), wherein the coherency agents 201 and 202 are assigned to coherency domain 1, the coherency agents 203 and 204 are assigned to coherency domain 2, and coherency agents 202 and 204 are assigned to coherency domain 3. Thus, the coherency agent 202 is assigned to two coherency domains, coherency domain 1 and coherency domain 3, and the coherency agent 204 is also assigned to two coherency domains, coherency domain 2 and coherency domain 3. Based on this domain assignment, the address translation tables of the address translation components 220 of the coherency agents 201-204 are configured such that each virtual address entry includes one or more DIDs for the one or more corresponding coherency domains.

To facilitate routing of coherency domain-specific coherency messages between the coherency agents 201-204, the system interconnect 214 includes a routing table 222 (corresponding to routing table 122, FIG. 1) that identifies the correspondence between coherency agents and domain identifiers. Table 2 illustrates a basic implementation of the routing table 222 for the example of FIG. 2 that can be used to limit the distribution of the coherency message to only those coherency agents associated with coherency domains identified by the coherency message based on a mapping of the DID(s) supplied with a coherency message to the routing information of the routing table 222. As also illustrated by Table 2, in the event that no DID is supplied (or a default or global DID is supplied, the coherency message is broadcast to all coherency agents.

TABLE 2
Routing Table 222 for FIG. 2

| DID | Agent 201 | Agent 202 | Agent 203 | Agent 204 |
|---|---|---|---|---|
| 1 | Y | Y | N | N |
| 2 | N | N | Y | Y |
| 3 | N | Y | N | Y |
| — | Y | Y | Y | Y |

FIG. 3 depicts another multiple-processor system 300 that includes a plurality of coherency agents, including coherency agents 301, 302, 303, and 304 (hereinafter, “coherency agents 301-304”) that share a coherent memory (not shown). The coherency agents 301-304 each can include an address translation component 320 (corresponding to the address translation component 120, FIG. 1). In the example of FIG. 3, the coherency agents 301 and 302 comprise one processing node on one integrated circuit substrate and thus are connected via an intra-node interconnect 315 and the coherency agents 303 and 304 together comprise another processing node on another integrated circuit substrate and thus are connected via an intra-node interconnect 316. The intra-node interconnects 315 and 316 are connected via a system interconnect 314 (corresponding to the system interconnect 114, FIG. 1). The intra-node interconnects 315 and 316 are configured to transmit coherency messages and interprocessor messages within their respective processing nodes and the system interconnect 314 is configured to transmit coherency messages and interprocessor messages between processing nodes.

In the illustrated example, the multiple-processor system 300 is divided into two coherency domains (coherency domains 1 and 2), one for each processing node, wherein the coherency agents 301 and 302 are assigned to coherency domain 1 and the coherency agents 303 and 304 are assigned to coherency domain 2. Based on this coherency domain assignment, the address translation tables of the address translation components 320 each is configured such that each virtual address entry includes a DID for the corresponding coherency domain.

The intra-node interconnect 315 includes a routing table 323 to facilitate routing of coherency messages between the coherency agents 201 and 202 and the system interconnect 314. Likewise, the intra-node interconnect 316 includes a routing table 324 to facilitate routing of coherency messages between the coherency agents 303 and 304 and the system interconnect 314. The system interconnect 314 includes a routing table 322 to facilitate routing of coherency messages between the intra-node interconnect 315 and the intra-node interconnect 316. Tables 3-5 illustrate basic implementations of the routing table 322, 323, and 324, respectively that can be used to limit the distribution of the coherency message to only those coherency agents associated with coherency domains identified by the coherency message based on a mapping of the DID(s) supplied with a coherency message to the routing information of the routing tables 322-324.

TABLE 3
Routing Table 322 for FIG. 3

| | Intra-Node | Intra-Node |
|---|---|---|
| DID | Interconnect 315 | Interconnect 316 |
| 1 | Y | N |
| 2 | N | Y |
| — | Y | Y |

TABLE 4
Routing Table 323 for FIG. 3

| | | | System |
|---|---|---|---|
| DID | Agent 301 | Agent 302 | Interconnect |
| 1 | Y | Y | N |
| 2 | N | N | Y |
| — | Y | Y | Y |

TABLE 5
Routing Table 324 for FIG. 3

| | | | System |
|---|---|---|---|
| DID | Agent 303 | Agent 304 | Interconnect |
| 1 | N | N | Y |
| 2 | Y | Y | N |
| — | Y | Y | Y |

FIG. 4 illustrates an example processor core 400 utilizing coherency-domain specific coherency messaging in accordance with at least one embodiment of the present disclosure). The processor core 400 includes an instruction pipeline 402, an instruction cache 404, a data cache 406, an instruction memory management unit (MMU) 408, a data MMU 410, and a bus interface unit (BIU) 412, which is connected to a coherency interconnect, such as a system interconnect or an intra-node interconnect (not shown). The instruction pipeline 402 includes a plurality of instruction execution stages, such as an instruction unit 414 for accessing and processing instruction data from the instruction cache 404 via the instruction MMU 408, and a load/store unit (LSU) 416 for performing load operations and store operations that result from the processing of the instruction data.

In the event that of a load operation or a store operation, the LSU 416 provides a virtual address 420 to the data MMU 410 (along with write data in the event of a store operation). The data MMU 410 translates the virtual address 420 to a physical address 422 using a translation lookaside buffer (TLB) 424 or other address translation table. The data MMU 410 then provides the physical address 422 to the data cache 406 to identify the cache location involved with the load/store operation. Further, as part of the address translation, the data MMU 410 can identify one or more coherency domains associated with the virtual address 420 and provide the DID 426 of each of the identified coherency domains to the BIU 412.

In the event that the load/store operation to the cache location specified by the physical address 422 has coherency ramifications, the data cache 406 can provide a coherency indicator 428 to the BIU 412 to direct the BIU 412 to generate a coherency message. The coherency indicator 428 can include, for example, the physical address 422, the data value of the cache location prior to modification, the data value of the cache location after modification, the one or more DIDs identified by the data MMU 410, and the like.

In response to the coherency indicator 428, the BIU 412 generates a coherency message 430 with the relevant information and provides the coherency message 430 to the coherency interconnect for transmission to the appropriate coherency agents. Further, the BIU 412 provides the one or more DIDs 426 identified by the data MMU 410 during the address translation to the coherency interconnect, either as a separate signal or as part of the coherency message 430 itself. The coherency interconnect then can use the provided DIDs 426 to limit the transmission of the coherency message 430 to only the identified coherency domains.

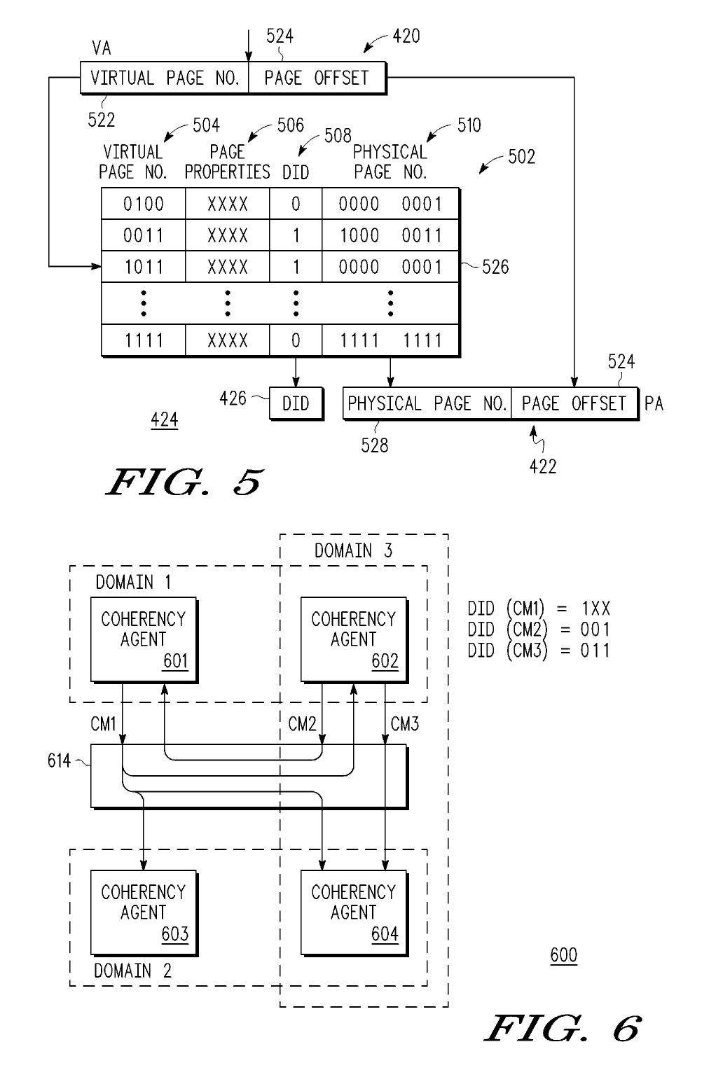

FIG. 5 illustrates an example implementation of the TLB 424 of FIG. 4 in accordance with one embodiment of the present disclosure. As illustrated, the TLB 424 includes one or more address translation tables 502 used to translate the virtual address 420 to the physical address 422. The address translation table 502 includes a plurality of entries, each entry comprising a virtual page number field 504, a page properties field 506, a DID field 508, and aphysical page number field 510. The DID field 508 of each entry is configured to store one or more DIDs of coherency domains associated with the corresponding virtual page number. Thus, virtual pages are mapped to corresponding coherency domains in the implementation of FIG. 5.

In one embodiment, the virtual address 420 includes a virtual page number 522 that identifies a particular virtual page number 522 and a page offset 524 that identifies a particular page offset. The TLB 424 indexes an entry 526 of the address translation table 502 using the virtual page number and the virtual page number field 504. The TLB 424 then accesses a physical page number 528 from the physical page number field 510 of the indexed entry 526 and combines the physical page number 528 with the page offset 420 to generate a unique address value for the physical address 422. Further, the TLB 424 accesses the DID field 508 of the indexed entry 526 to obtain one or more DIDs 426 associated with the corresponding virtual page and outputs the DIDs 426 to a BIU or other coherency interface as described above.

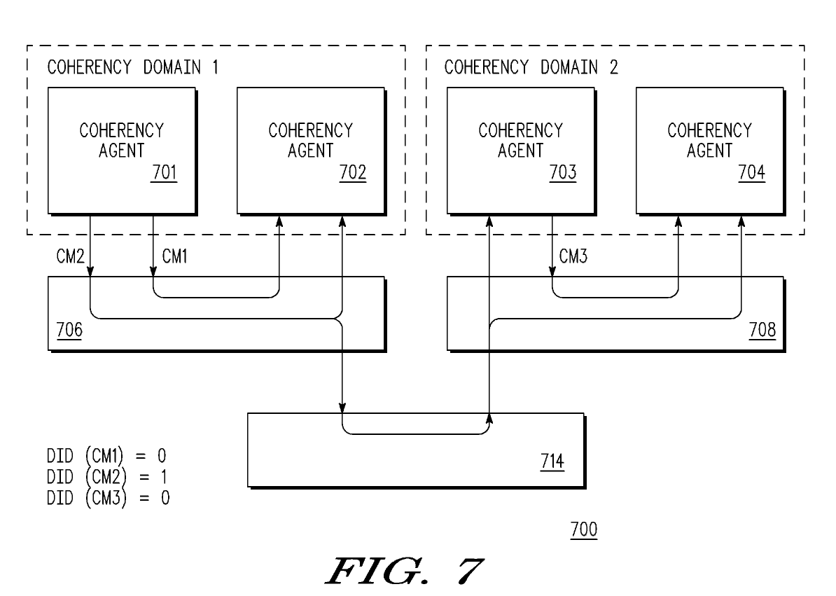

FIGS. 6 and 7 illustrate examples of coherency domain-specific routing of coherency message routing in accordance with at least one embodiment of the present disclosure. FIG. 6 illustrates the routing of coherency messages CM1, CM2, and CM3 in a multiple-processor system 600 having a coherency agent 601 associated with coherency domain 1, a coherency agent 602 associated with coherency domains 1 and 3, a coherency agent 603 associated with coherency domain 2, and a coherency agent 604 associated with coherency domains 2 and 3. The coherency agent 601 provides the coherency message CM1 to a system interconnect 614, wherein the coherency message CM1 includes a DID of “1XX”. The coherency agent 602 provides the coherency messages CM2 and CM3 to the system interconnect 614, wherein the coherency message CM2 includes a DID of “001” and the coherency message CM3 includes a DID of “011”.

In the example of FIG. 6, the first bit position of a DID indicates whether a corresponding coherency message is to be transmitted system-wide or to only a subset of the coherency domains (e.g., a “1” indicates system-wide and a “0” indicates a select subset of coherency domains). In the event that the first bit position of the DID is asserted (e.g., is a “1”), the second and third bit positions of a DID indicate the particular coherency domain to which a corresponding coherency message is to be distributed. Accordingly, the system interconnect 614 transmits the coherency message CM1 to all of the coherency agents in the multiple-processor system 600, transmits the coherency message CM2 to only the coherency agent 601, and transmits the coherency message to only the coherency agent 604.

FIG. 7 illustrates the routing of coherency messages CM1, CM2, and CM3 in a multiple-processor system 700 having coherency agents 701 and 702 associated with coherency domain 1 and coherency agents 703 and 704 associated with coherency domain 2. The coherency agents 701 and 702 are connected to an intra-node interconnect 706 and the coherency agents 703 and 704 are connected to an intra-node interconnect 708. The intra-node interconnects in turn are connected via a system interconnect 714.

In one embodiment, a DID of “0” is used to signify a local coherency domain (e.g., the coherency domain of each of the intra-node interconnects 706 and 708) and a DID of “1” is used to signify a global coherency domain of all coherency agents of the multiple-processor system 700. Accordingly, the intra-node interconnect 706 is configured to route coherency messages having a DID of “0” to only those coherency agents connected to the intra-node interconnect 706 and to route coherency messages having a DID of “1” to both those coherency agents connected to the intra-node interconnect 706 and to the system interconnect 714 to distribute to other coherency agents directly or indirectly connected to the system interconnect 714. Likewise, the intra-node interconnect 708 is configured to route coherency messages having a DID of “0” to only those coherency agents connected to the intra-node interconnect 708 and to route coherency messages having a DID of “1” to both those coherency agents connected to the intra-node interconnect 706 and to the system interconnect 714 to distribute to other coherency agents directly or indirectly connected to the system interconnect 714. Thus, a DID of “0” serves to limit the transmission of a coherency message to only the local coherency domain and a DID of “1” serves to broadcast a coherency message to all coherency agents of the multiple-processor system 700.

In the illustrated example, the coherency agent 701 provides the coherency messages CM1 and CM2 to the intra-node interconnect 706 and the coherency agent 703 provides the coherency message CM3 to the intra-node interconnect 708. The coherency messages CM1, CM2, and CM3 have DIDs of “0”, “1”, and “0,” respectively. Based on the DIDs of the coherency messages CM1 and CM2, the intra-node interconnect 706 transmits the coherency message CM1 to only the coherency agent 702, but transmits the coherency message CM2 to both the coherency agent 702 and to the system interconnect 714, which provides it to the intra-node interconnect 708 for transmission to the coherency agents 703 and 704. Based on the DID of the coherency message CM3, the intra-node interconnect 708 transmits the coherency message CM3 to only the coherency agent 704.

The terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

The term “another”, as used herein, is defined as at least a second or more. The terms “including”, “having”, or any variation thereof, as used herein, are defined as comprising. The term “coupled”, as used herein with reference to electro-optical technology, is defined as connected, although not necessarily directly, and not necessarily mechanically.

Other embodiments, uses, and advantages of the disclosure will be apparent to those skilled in the art from consideration of the specification and practice of the disclosure disclosed herein. The specification and drawings should be considered exemplary only, and the scope of the disclosure is accordingly intended to be limited only by the following claims and equivalents thereof.

What is claimed is:

1. In a processing system comprising a plurality of coherency domains and a plurality of coherency agents, each coherency agent associated with at least one of the plurality of coherency domains, a method comprising:
performing, at a first coherency agent of the plurality of coherency agents, a first address translation for a first coherency message using a first memory address to generate a second memory address;
determining, at the first coherency agent, a first coherency domain of the plurality of coherency domains associated with the first coherency message based on the first address translation; and
providing the first coherency message and a first coherency domain identifier of the first coherency domain to a coherency interconnect for distribution to at least one of the plurality of coherency agents based on the first coherency domain identifier.

2. The method of claim 1, further comprising:
performing, at a second coherency agent of the plurality of coherency agents, a second address translation for a second coherency message using a third memory address to generate the second memory address;
determining, at the second coherency agent, a second coherency domain of the plurality of coherency domains associated with the second coherency message based on the second address translation; and
providing the second coherency message and a second coherency domain identifier of the second coherency domain to the coherency interconnect for distribution to at least one of the plurality of coherency agents based on the second coherency domain identifier.

3. The method of claim 2, further comprising:
distributing the first coherency message to each coherency agent of the plurality of coherency agents that is associated with the first coherency domain based on the first coherency domain identifier; and
distributing the second coherency message to each coherency agent of the plurality of coherency agents that is associated with the second coherency domain based on the second coherency domain identifier.

4. The method of claim 1, wherein performing the first address translation comprises:
identifying a select entry of an address translation table based on a first portion of the first memory address;
accessing a select address value from a first field of the select entry; and
generating the second memory address based on the select address value and a second portion of the first memory address.

5. The method of claim 4, wherein determining the first coherency domain comprises accessing the first coherency domain identifier from a second field of the select entry.

6. The method of claim 1, further comprising:
distributing the first coherency message to each coherency agent of the plurality of coherency agents that is associated with the first coherency domain based on the first coherency domain identifier.

7. The method of claim 1, wherein:
the plurality of coherency domains comprises a local coherency domain comprising a subset of the plurality of coherency agents and a global coherency domain including the plurality of coherency agents.

8. A processor device comprising:
a coherency agent; and
a memory management unit comprising an address translation table comprising a plurality of entries, each entry comprising a first field to store a corresponding address value and a second field to store a coherency domain identifier of a corresponding coherency domain of a plurality of coherency domains.

9. The processor device of claim 8, wherein the memory management unit is configured to index a select entry of the address translation table based on a first portion of a first memory address associated with a coherency message and configured to generate a second memory address based on a second portion of the first memory address and a select address value stored in the first field of the select entry.

10. The processor device of claim 9, wherein the coherency agent is coupled to a coherency interconnect and configured to provide a coherency message to the coherency interconnect, the coherency message including a coherency domain identifier stored in the second field of the select entry.

11. The processor device of claim 9, wherein the first memory address comprises a virtual address and the second memory address comprises a physical address.

12. The processor device of claim 11, wherein the first portion of the first memory address comprises a virtual page number, the second portion of the first memory address comprises a page offset, and the select address value comprises a physical page number.

13. The processor device of claim 8, wherein the coherency agent is coupled to a coherency interconnect and configured to provide a coherency message to the coherency interconnect, the coherency message including a coherency domain identifier stored in the second field of a select entry of the plurality of entries.

14. The processor device of claim 8, wherein the plurality of entries comprises:
a first entry comprising a first address value stored in the first field, a first coherency domain identifier stored in the second field, and a second address value stored in a third field; and
a second entry comprising a third address value, different from the first address value, stored in the first field, a second coherency domain identifier, different than the first coherency domain identifier, stored in the second field, and the third address value stored in a third field.

15. The system of claim 8, wherein each of the plurality of coherency agents is selected from a group consisting of: a processor core; and a stand-alone cache.

16. A system comprising:
a plurality of coherency agents, each coherency agent being associated with at least one of a plurality of coherency domains and comprising an address translation table, each coherency agent configured to:
generate a coherency message in response to a cache access at the coherency agent; and
determine a coherency domain identifier for the coherency message based on the address translation table and a first memory address associated with the cache access, the coherency domain identifier associated with a select coherency domain of the plurality of coherency domains; and
a coherency interconnect configured to distribute the coherency message between select ones of the plurality of coherency agents based on the coherency domain identifier associated with the coherency message.

17. The system of claim 16, wherein:
the plurality of coherency agents comprises a first processing node comprising a first subset of coherency agents and a second processing node comprising a second subset of coherency agents; and
the coherency interconnect comprises:
a first intra-node interconnect coupled to the first subset of coherency agents; and
a second intra-node interconnect coupled to the second subset of coherency agents.

18. The system of claim 16, wherein each coherency agent is configured to determine a coherency domain identifier for the coherency message by:
accessing a select entry of the address translation table based on a first portion of the first memory address; and
accessing a first field of the select entry to determine the coherency domain identifier.

19. The system of claim 18, wherein each coherency agent further is configured to generate a second memory address based on a second portion of the first memory address and an address value stored at a second field of the select entry.

20. The system of claim 16, wherein each of the plurality of coherency agents is selected from a group consisting of: a processor core; and a stand-alone cache.

21. A method comprising:
providing an address translation table comprising a plurality of address translation entries, each entry comprising a corresponding domain identifier field configured to store a domain identifier; and
wherein the domain identifier of a corresponding domain identifier field identifies a corresponding coherency domain of a plurality of coherency domains for a plurality of coherency agents.
